(19) United States
(12) Patent Application Publication
(10) Pub. No.: US 2007/0089361 A1
(43) Pub. Date: Apr. 26, 2007

(54) Floral container and methods of use thereof

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 11/582,640

(22) Filed: Oct. 18, 2006

Related U.S. Application Data
(60) Provisional application No. 60/728,539, filed on Oct. 20, 2005.

(51) Int. Cl. A47G 7/00; A01G 5/00

(52) U.S. Cl. 47/41.01

(57) ABSTRACT

A flexible floral container comprising an inner membrane for acting as a reservoir or “catch basin” to minimize water spillage when the flexible floral container having a fluid medium therein is tipped over. The stems of a floral grouping disposed in the flexible floral container provide structural support to the flexible floral container and cooperate to maintain the flexible floral container in a substantially erect condition.

### CROSS-REFERENCE TO RELATED APPLICATIONS

This application claims the benefit under 35 U.S.C. 119(e) of provisional application U.S. Ser. No. 60/728,539, filed Oct. 20, 2005. The entire contents of the above-referenced application is hereby expressly incorporated herein by reference.

### STATEMENT REGARDING FEDERALLY SPONSORED RESEARCH OR DEVELOPMENT

Not Applicable.

### FIELD OF THE INVENTION

This invention is related to the field of containers for containing cut flowers, and more particularly to such containers which are flexible.

### SUMMARY OF THE PRESENT INVENTION

The present invention is related to a floral container and methods of use thereof. The floral container includes a floral vase having a sidewall, an open upper end, a closed lower end, an outer surface and an inner surface encompassing an interior space. The floral container further includes an inner membrane extending across a portion of the interior space of the vase. In one embodiment, a first portion of the membrane may be attached to a first portion of the inner surface of the vase and at least a second portion attached to a second portion of the inner surface of the vase. In another embodiment, the inner membrane may not be attached to the flexible floral vase.

In one embodiment, the floral vase, and thus the floral container formed therefrom, are flexible.

The inner membrane may separate the interior space of the vase into an upper interior space above the inner membrane and a lower interior space below the inner membrane. The inner membrane may comprise at least one opening for allowing passage of water, plant stems, and/or other items or materials therethrough into the lower interior space of the vase.

The floral container may further include a second inner membrane attached to the inner surface of the vase above or below the first mentioned inner membrane. The inner membrane(s) may be formed or flexible, rigid or semi-rigid materials.

The floral container may further include an inner tube having an upper end with an upper opening and a lower end with a lower opening. The upper end of the inner tube may be attached to the vase near the upper end thereof such that the upper opening of the inner tube is congruent with the open upper end of the vase. The lower end of the inner tube may be attached to an inner bottom surface of the vase, the inner membrane of the vase, or the inner surface of the vase.

The floral container may further include a plurality of openings in an upper portion of the vase. Each opening may be sized to receive a plant stem when the upper portion of the vase having the plurality of openings is inverted into the interior space of the vase.

The floral container may further include a rigid or semi-rigid disk for supporting plant stems disposed within the interior space of the vase. The rigid or semi-rigid disk may be free from attachment to the inner surface of the vase. The rigid or semi-rigid disk may include a plurality of openings for receiving the plant stems. In addition, the rigid or semi-rigid disk may have a central opening and a plurality of peripheral openings outside the central opening. The central opening in the rigid or semi-rigid disk may have a serrated edge and a protuberance extending into the central opening.

The inner membrane of the floral container may have a substantially flat shape, a substantially conical or convex shape, or a substantially funnel or concave shape.

The floral container may be constructed of one or more layers of material.

In another embodiment, the present invention is related to a flexible floral container that includes a flexible vase and a plurality of retaining members. The flexible vase has a sidewall, an open upper end, a closed lower end, an outer surface and an inner surface encompassing an interior space. The plurality of retaining members may be attached to or formed in at least a portion of the sidewall of the vase. Each retaining member is sized to receive at least a portion of at least one plant stem.

The floral container may further include an inner membrane extending across a portion of the interior space. A first portion of the membrane may be attached to a first portion of the inner surface of the vase and at least a separate second portion attached to a separate second portion of the inner surface of the vase.

The flexible floral vase of the flexible flora container may be formed of one or more layers of material. In one embodiment, the flexible vase is formed of at least two layers of material, and the plurality of retaining members are attached to or formed in an inner layer of material.

In yet another embodiment, the present invention is related to a flexible floral container that includes a flexible vase and at least one tube within an interior space of the vase. The flexible vase has having an open upper end, a closed lower end, an outer surface and an inner surface encompassing the interior space. The at least one tube is attached to the inner surface of the vase and is sized to receive a plant stem inserted into the vase through the open upper end.

The flexible floral container may further include an inner membrane extending across a portion of the interior space, with a first portion of the membrane attached to a first portion of the inner surface of the vase and at least a separate second portion attached to a separate second portion of the inner surface of the vase.

An upper end of the at least one tube may be attached to the vase near the upper end thereof such that an upper opening of the at least one tube is congruent with the open upper end of the vase. A lower end of the at least one tube may be anchored within the vase. The lower end of the inner tube may be attached to an inner bottom surface of the vase. A lower portion of the inner tube may have a plurality of openings in a sidewall thereof for allowing passage of water or other fluids. The at least one tube may extend from near the open upper end of the vase to near the closed lower end of the vase. In addition, the at least one tube may include a plurality of tubes or tunnels formed within an inner layer of the vase.

In yet another embodiment of the present invention, a flexible floral container is provided that includes a flexible vase and a stem support assembly. The flexible vase has a sidewall, an open upper end, a closed lower end, an outer surface and an inner surface encompassing an interior space. The stem support assembly includes an upper disk, a lower disk, and a tubular member connecting the upper disk to the lower disk. The upper disk and the lower disk each have at least one opening therein, wherein the at least one opening is sized to receive a plant stem. The upper disk may have a diameter which is smaller than the diameter of the lower disk. In addition, the upper disk may have a groove in an outer peripheral edge thereof which extends about the circumference of the upper disk, wherein the groove can receive a securing element for securing the vase to the upper disk.

The flexible container may further include an inner membrane extending across a portion of the interior space, with a first portion of the membrane attached to a first portion of the inner surface of the vase and at least a separate second portion attached to a separate second portion of the inner surface of the vase.

The present invention is also related to a method of providing a plant package. The method includes providing any of the floral containers described herein above, providing at least one cut flower having a stem, and disposing at least a portion of the stem of the at least one cut flower within an interior space of the floral container. The method may further include securing the floral container about the at least one cut flower via a securing element.

In another embodiment of the present invention, a plurality of cut flowers are provided and disposed within any of the floral containers described herein. In such method, at least a portion of the stems of the cut flowers are disposed through the opening(s) formed in an inner membrane (or retaining members, tube or stem support assembly) so that the stems assume a tripod or tipi shape and provide structural integrity to the floral container and thus cooperate to maintain the floral container in a substantially erect condition.

The present invention is also related to plant packages formed by the methods described herein above.

Other objects, features and advantages of the present invention will become apparent from the following detailed description when read in conjunction with the accompanying figures and appended claims.

### BRIEF DESCRIPTION OF THE DRAWINGS

FIG. 1 is a cross-sectional view of a flexible container constructed in accordance with the present invention.

FIG. 2 is a top plan view of an inner membrane of the flexible container of FIG. 1.

FIG. 3 is a perspective view of an alternate configuration of a flexible container of the present invention.

FIG. 4 is a perspective view of an alternate configuration of a flexible container of the present invention.

FIG. 5 is a perspective view of an alternate configuration of a flexible container of the present invention.

FIG. 6 is a perspective view of an alternate configuration of a flexible container of the present invention.

FIG. 7 is a perspective view of an alternate configuration of a flexible container of the present invention.

FIG. 8 is a top plan view of an alternate configuration of the inner membrane of the flexible container of FIG. 1.

FIG. 9 is a top plan view of an alternate configuration of the inner membrane of the flexible container of FIG. 1.

FIG. 10 is a cross-sectional view of a plant package having cut flowers and the flexible container of FIG. 1.

FIG. 10a is a cross-sectional view of the plant package of FIG. 10 including a securing element disposed thereabout.

FIG. 11 is a cross-sectional view of the plant package of FIG. 10a tipped over on its side to demonstrate how water in the flexible container is captured by the inner membrane.

FIG. 12 is a cross-sectional view of an alternate embodiment of the flexible container of the present invention.

FIG. 13 is a cross-sectional view of the flexible container of FIG. 12 containing cut flowers.

FIG. 14 is a cross-sectional view of an alternate embodiment of the flexible container of the present invention.

FIG. 15 is a cross-sectional view of the flexible container of FIG. 14 containing cut flowers.

FIG. 16 is a cross-sectional view of an alternate embodiment of the flexible container of the present invention.

FIG. 17 is a cross-sectional view of the flexible container of FIG. 16 containing cut flowers.

FIG. 18 is a cross-sectional view of an alternate embodiment of the flexible container of the present invention.

FIG. 19 is a cross-sectional view of an alternate embodiment of the flexible container of the present invention.

FIG. 20 is a plan view of the upper support disk of the flexible container of FIG. 19.

FIG. 21 is a plan view of an alternate version of the upper support disk of the flexible container of FIG. 19.

FIG. 22 is a plan view of an alternate version of the upper support disk of the flexible container of FIG. 19.

FIG. 23 is a plan view of an alternate version of the upper support disk of the flexible container of FIG. 19.

FIG. 24 is a cross-sectional view of an alternate embodiment of the flexible container of the present invention.

FIG. 25 is a cross-sectional view of an alternate embodiment of the flexible container of the present invention.

FIG. 26 is a cross-sectional view of the flexible container of FIG. 25 containing cut flowers.

FIG. 27 is a cross-sectional view of an alternate embodiment of the flexible container of the present invention.

FIG. 28 is a cross-sectional view of an alternate embodiment of the flexible container of the present invention.

FIG. 29 is a cross-sectional view of an alternate embodiment of the flexible container of the present invention.

FIG. 30 is a cross-sectional view of the flexible container of FIG. 29 containing cut flowers.

FIG. 31 is a cross-sectional view of an alternate embodiment of the flexible container of the present invention.

FIG. 32 is a top plan view of the flexible container of FIG. 31.

FIG. 33 is a cross-sectional view of the flexible container of FIG. 31 containing cut flowers.

FIG. 34 is a cross-sectional view of an alternate embodiment of the flexible container of the present invention.

FIG. 35 is a cross-sectional view of the flexible container of FIG. 34 containing cut flowers.

FIG. 36 is a cross-sectional view of an alternate embodiment of the flexible container of the present invention.

FIG. 37 is a top plan view of the flexible container of FIG. 36.

FIG. 38 is a perspective view of a stem support assembly for use in a flexible container.

FIG. 39 is a perspective view of the stem support assembly of FIG. 38 disposed within a flexible container with cut flowers.

FIG. 40 is a cross-sectional view of the stem support assembly of FIG. 38 disposed within a flexible container with cut flowers.

### DETAILED DESCRIPTION OF THE INVENTION

The present invention contemplates a flexible floral container for containing cut flowers. The flexible floral container is preferably constructed so as to be free-standing when at least partially filled with water or other medium which, along with one or more stems of a floral grouping disposed therein, serves as a ballast. The flexible floral container comprises a flexible floral vase and a membrane disposed therein, wherein the membrane functions to maintain the stems of a floral grouping in a substantially erect position and prevents the flexible floral container from tipping over, thus allowing one or more stems of the floral grouping to act as structural members for maintaining the flexible floral container in a substantially erect condition.

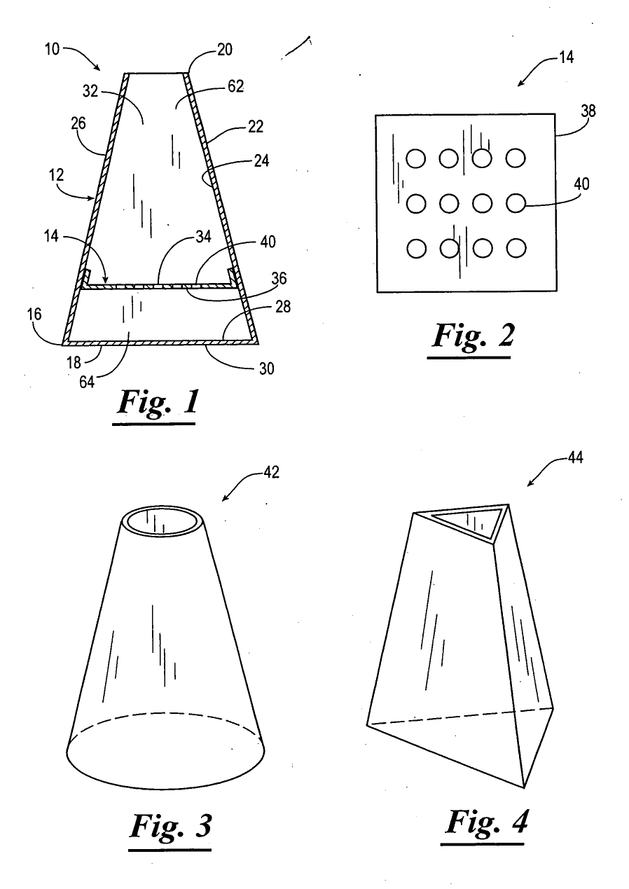

In one embodiment, shown in FIG. 1, a flexible floral container (also referred to herein as “container”, “flexible floral vase” or simply “vase”) of the present invention is designated by the general reference numeral 10. The container 10 comprises a flexible floral vase 12 and an inner membrane 14. The flexible floral vase 12 may be formed of a bag, sleeve or sheet of material formed into a vase-type structure. The flexible floral vase 12 may be constructed from a waterproof material, or the flexible floral vase 12 may be constructed of multiple layers of material wherein at least an inner layer thereof is waterproof. The flexible floral vase 12 has a closed lower end 16 having a bottom 18, an upper end 20 which is preferably open, and a sidewall 22. The sidewall 22 has an inner surface 24 and an outer surface 26, and the bottom 18 has an inner surface 28 and an outer surface 30. The inner surfaces 24 and 28 encompass an interior space 32 within the vase 12. In certain embodiments the upper end 20 is open, but in other embodiments the upper end 20 may be closed. The inner membrane 14 has an upper surface 34, a lower surface 36, and an outer peripheral edge 38 (see FIG. 2). The inner membrane 14 may be provided with any shape, and a square shape is shown in FIG. 2 for the purposes of illustration only; however, it is to be understood that the inner membrane 14 may have a circular, oval, elliptical, rectangular, hexagonal, octagonal, pentagonal, or trapezoidal shape, or any other shape known in the art. In certain embodiments, the inner membrane 14 is provided with a shape that matches the inner circumference (or other perimeter shape) of the vase 12.

The inner membrane 14 may be attached to at least a portion of the inner surface 24 of the vase 12. The inner membrane 14 may be partially or completely attached along its outer peripheral edge 38 or along a portion of the inner membrane 14 near the outer peripheral edge 38. The inner membrane 14 may be attached to the inner surface 24 of the vase 12 by any appropriate means, including but not limited to, heat sealing, welding, taping, and adhesive or cohesive bonding materials. In alternative embodiments, the inner membrane 14 may not be attached to the vase 12, as described in greater detail herein after.

The inner membrane 14 may have at least one opening 40 formed therein; optionally, the inner membrane 14 may be formed of a sufficiently thin material or may have portions thereof that are sufficiently thinner than the remainder of the inner membrane 14 such that at least one opening 40 can easily be made therein, as discussed in more detail herein below. The one or more openings 40 in inner membrane 14 may be positioned more or less in a middle portion (FIG. 2) therein, or in a more peripheral portion thereof, or both. In certain embodiments, at least one of the one or more openings 40 are positioned in close proximity to the outer peripheral edge 38 of the inner membrane 14, so that stems of flowers inserted therethrough can be positioned in close proximity to the sidewall 22 of the vase 12 and provide structural support thereto.

The inner membrane 14 may be constructed without one or more preconstructed openings 40. In such an embodiment, the inner membrane 14 may not be connected completely along the outer peripheral edge 38 to the inner surface 24 of the vase 12, and at least one opening 40 is formed between the inner surface 24 of the vase 12 and an unattached portion of the outer peripheral edge 38 of the inner membrane 14. Alternatively, the inner membrane 14 may be completely attached along the outer peripheral edge 38 thereof to the inner surface 24 of the vase 12, and the inner membrane 14 may be constructed of a material which can be readily pierced by a stem of a plant or cut flower to form one or more openings 40.

The inner membrane 14 may be any shape appropriate for a shape of the vase 12. For example, if the vase 12 when opened has a shape which is square or rectangular in cross-section, the inner membrane 14 may have a square or rectangular shape, respectively. Alternatively, when the vase 12 when open has a circular, oval, or elliptical shape in cross-section, the inner membrane 14 may have a circular, oval or elliptical shape, respectively.

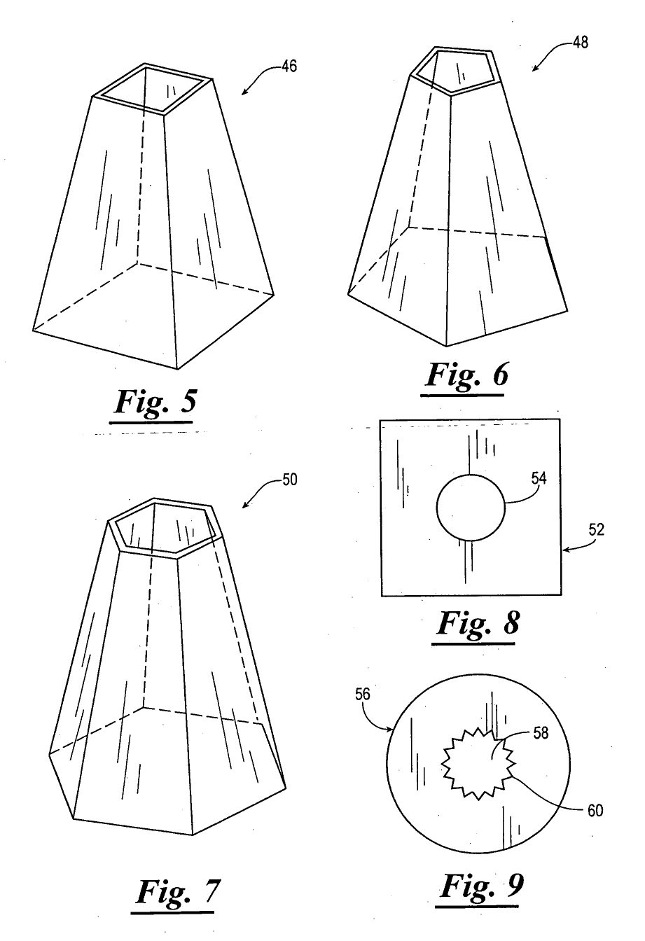

The flexible floral vase 12 or any other vase shown herein may have any one of a variety of shapes. In certain embodiments the vase 12 has a shape of a frustum (i.e., having a truncated top), when open. For example the vase 12 may have a frusto-conical shape 42 (as shown in FIG. 3). Similarly, the vase 12 may have a frusto-polyhedral shape, including, but not limited to, a frusto-tetrahedron 44 (a three-sided pyramid with a flat (open) top, as shown in FIG. 4) a frusto-pentahedron 46 (a four-sided pyramid, as shown in FIG. 5), a frusto-hexahedron 48 (a five-sided pyramid, as shown in FIG. 6), and a frusto-heptahedron 50 (a six-sided pyramid, as shown in FIG. 7). Optionally, the vase 12 may have a more cylindrical shape without a substantial taper. The inner membrane 14 may have a shape which corresponds to a transection of the vase 12 within which it is disposed; for example, the frusto-pyramidal container 46 of FIG. 5 would have a square-shaped inner membrane 14, while the frusto-hexagonal container 48 of FIG. 6 would have a pentagon-shaped inner membrane 14.

The flexible floral vase 12 may be constructed to have an initially flattened condition to promote ease of shipping and storage. The vase 12 may have appropriately positioned gussets or folds in the sidewall 22 and/or bottom 18 for enabling the vase 12 to be opened from the flattened condition or collapsed from the opened condition to a flattened condition. Examples of how a vase 12 could be constructed to have such gussets or folds are shown in U.S. Pat. No. 6,779,301 which is hereby expressly incorporated by reference herein in its entirety.

As noted above, the inner membrane 14 may have a plurality of openings 40, as shown in FIG. 2, for receiving plant stems. Alternatively, as shown in FIG. 8, an inner membrane 52 is shown as having a single opening 54 for receiving one or more plant stems.

While the opening(s) of the inner membranes have been shown herein previously as being circular in shape, it is to be understood that the opening(s) may assume any shape that allows the inner membrane to function in accordance with the present invention. Shown in FIG. 9 is another embodiment of an inner membrane, designated therein by reference numeral 56, which has a single opening 58 which has a serrated inner edge 60 for enhancing the stabilizing effect of the inner membrane 56 against the stems of the plants inserted therein.

Returning now to a method of use of the flexible floral container 10 of the present invention, as shown in FIG. 1, the inner membrane 14 substantially separates the interior space 32 into an upper interior space 62 above the inner membrane 14 and a lower interior space 64 below the inner membrane 14. The lower interior space 64 serves generally as a reservoir for holding water or any other fluid or granular growth or retaining medium disposed within the container 10.

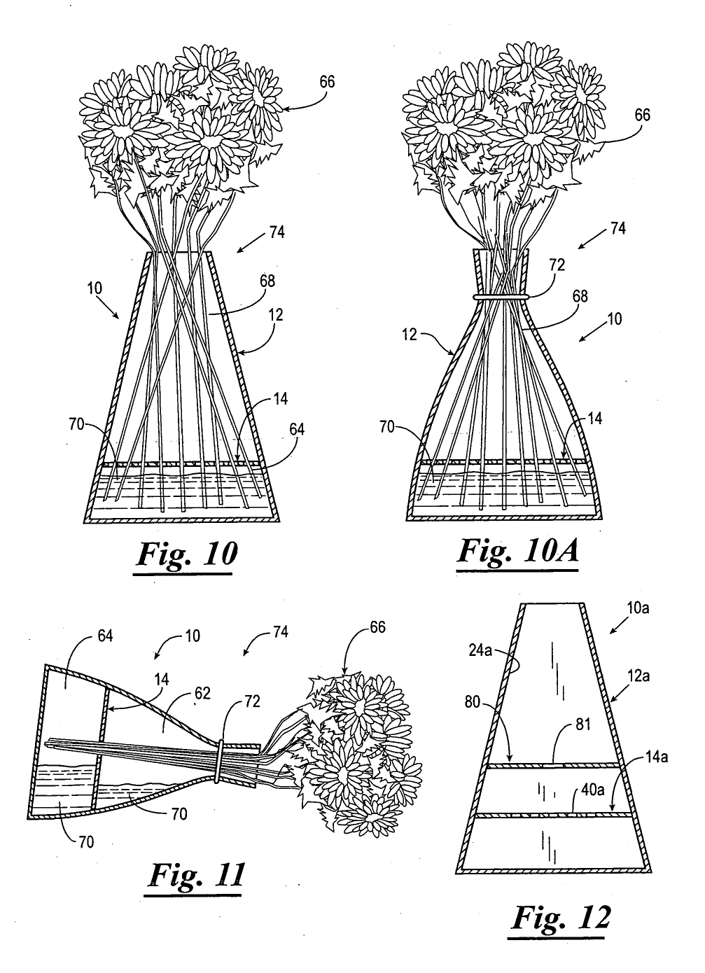

Shown in FIG. 10 and FIG. 10a is the flexible floral container 10 of FIG. 1 having a plurality of cut flowers 66 having stems 68 disposed therein. The stems 68 are positioned in a manner that forms a tripod or tipi shape that allows the stems 68 to act as structural members and cooperate with the flexible floral container 10 to maintain a plant package 74 formed therefrom in a substantially erect condition. Disposed within the lower interior space 64 below the inner membrane 14 is a quantity of water 70 or other fluid or granular growth or retaining medium. The inner membrane 14, while serving to gather and support the stems 68 of the cut flowers 66, also functions as a “catch basin” or “reservoir” to prevent substantial amounts of the water 70 or other medium from spilling from the container 10 if the container 10 is tipped over, falls over or collapses. As shown in FIG. 11, if the container 10 with the cut flowers 66 and water 70 therein falls over, most of the water 70 is retained by the inner membrane 14 within the lower interior space 64, while a small portion of the water 70 may spill into the upper interior space 62, thus preventing a major loss of the water 70 and the concomitant damage which might be caused due to the spillage of water 70 or other medium from the container 10.

In one embodiment the vase 12 of the container 10 is constructed of one or more layers of material, wherein at least one of the layers (or a combination of two or more layers) is a waterproof material such as a polymer film, including but not limited to, polyolefin films such as polyethylene and polypropylene. One or more layers of material from which the vase 12 is constructed may be a non-waterproof material, such as but not limited to, cloth, fabrics, paper, porous polymeric materials or the like. Such materials will have been rendered waterproof by lamination, attachment or use in combination with to a waterproof material such as a polyolefin such as polyethylene or polypropylene. Decorative patterns, designs, effects, colors, finishes, or materials may be applied to the inner surface 24 and/or outer surface 22 of the vase 12 of the container 10 for creating a decorative effect on the container 10.

The container 10 optionally may be secured about the stems 68 of the cut flowers 66 disposed therein via a securing element 72 as shown in FIG. 10A. The securing element 72 may be a band, including elastic or rubber bands. The securing element 72 may be any other type of material that can secure the container 10 about the stems 68 of the cut flowers 66, such as but not limited to, an adhesive, a cohesive, a string or elastic piece of material, non-elastic piece of material, a round piece of material, a flat piece of material, a ribbon, a piece of paper strip, a piece of plastic strip, a piece of wire, a tape, a staple, a tie wrap or a twist tie or combinations thereof or any other device capable of gathering portions of the container 10 to secure the container 10 about the cut flowers 66.

While cut flowers 66 are illustrated and described herein, it is to be understood that the present invention may be utilized with cut plants or a floral grouping as well. The term “floral grouping” as used herein means fresh cut flowers, dried cut flowers, cut plants, floral arrangements, floral bouquets, artificial flowers or plants, whole plants, including roots, and any other secondary plants or ornaments which add to the overall aesthetics of the arrangement with the container 10, as well as any combination thereof.

The container 10 with the cut flowers 66 disposed therein, and optionally a securing element 72 disposed thereabout, together comprise a plant package 74. The plant package may further comprise a fluid medium, growth medium or retaining medium 70, such as but not limited to, water, disposed therein.

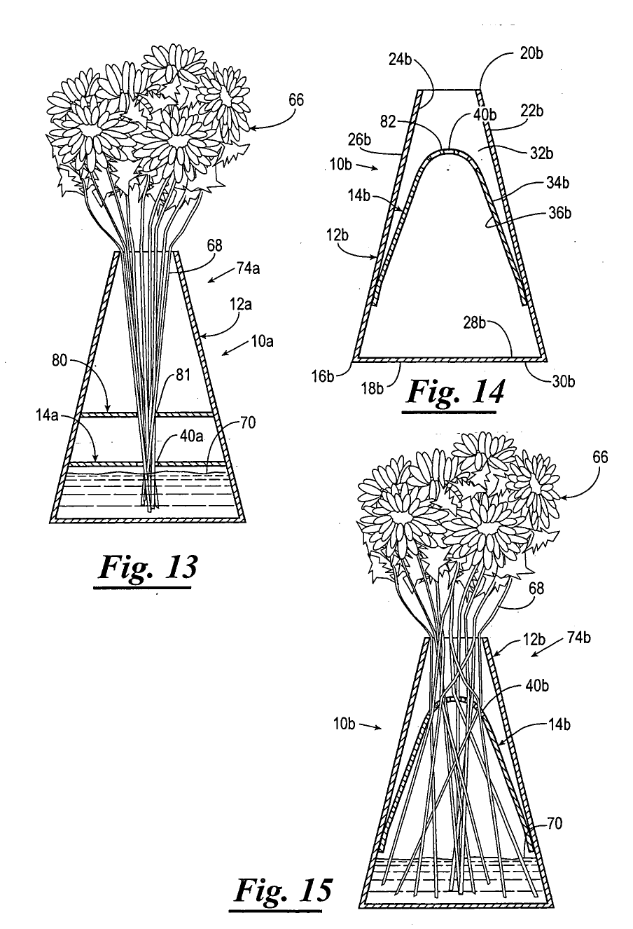

An alternate embodiment of the floral container of the present invention is shown in FIGS. 12 and 13 and is designated therein by the general reference numeral 10a. Container 10a is substantially the same as container 10 except container 10a has a first inner membrane 14a with an opening 40 and a second inner membrane 80 having at least one opening 81 formed therein. The at least one opening 81 of the second inner membrane 80 may be positioned at the same location or at a different location when compared to the at least one opening 40a of the first inner membrane 14a of container 10a, in a position above the first inner membrane 14a (both of the at least one openings 40a and 81 being like the openings 40 described previously). In one embodiment, the second inner membrane 80 is attached to an inner surface 24a of the vase 12a in a manner similar to that of inner membrane 14a which is attached in a similar manner. Alternatively, the second inner membrane 80 may not be attached to the vase 12a.

As shown in FIG. 13, cut flowers 66 are disposed within the vase 12a in a manner similar to container 10 except the stems 68 are inserted through the openings 40a and 81 of both the first inner membrane 14a and the second inner membrane 80, respectively, thereby forming a plant package 74a.

In FIG. 13, the inner membranes 14a and 80 are illustrated as each having single openings 40a and 81, respectively, formed therein. Therefore, the stems 68 of the cut flowers 66 cannot form the tripod or tipi shape discussed herein above so as to provide structural support to the floral container 10a. Therefore, the vase 12a of the floral container 10a must be formed of a rigid or semi-rigid material that allows the floral container 10a to maintain a substantially erect condition in the absence of the cut flowers 66. However, it is to be understood that a floral vase 12a may be constructed of a flexible material if the inner membranes 14a and 80 are provided with more than one openings 40a and 81 formed therein such that when cut flowers 68 are disposed therein, the stems 66 assume a tripod or tipi shape and thus provide structural support to the floral container 10a.

Shown in FIGS. 14 and 15 is an alternate embodiment of the container of the present invention designated by the general reference numeral 10b. Container 10b comprises a vase 12b having an inner membrane 14b disposed therein as previously described. The inner membrane 14b is shown as being attached to the vase 12b for illustration purposes only, and it is to be understood that the inner membrane 14b may not be attached to the vase 12b. The vase 12b has a closed lower end 16b having a bottom 18b, and an upper end 20b which may be open. The vase 12b has a sidewall 22b which has an inner surface 24b and an outer surface 26b. The bottom 18b has an inner surface 28b and an outer surface 30b. The inner membrane 14b has an upper surface 34b and a lower surface 36b and at least one opening 40b having a configuration similar to openings 40 discussed previously. Inner membrane 14b differs from inner membrane 14 primarily in that inner membrane 14b has a “bag-like” shape, for example a conical (convex) shape, wherein the inner membrane 14b has an upper end 82 disposed in a direction toward the upper end 20b of the vase 12b. Depending on the shape of the vase 12b (as described previously for vase 12), the inner membrane 14b may merely be a single sheet of material attached at two ends thereof to portions of the inner surface 24b of the vase 12b, or may have a shape which corresponds to a transection of the shape of the vase 12b within which the inner membrane 14b is attached. Shown in FIG. 15 is a plant package 74b comprising the container 10b, with cut flowers 66 and water or growing or retaining medium 70 disposed therein. The stems 68 form a tripod or tipi shape that provides structural integrity to the plant package 74b.

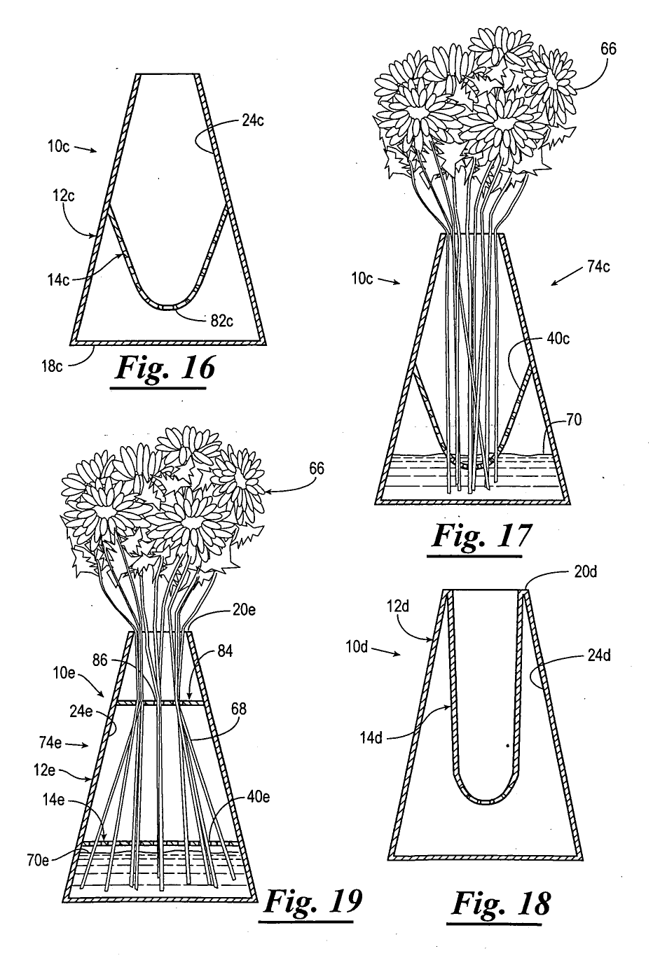

Shown in FIGS. 16-17 is an alternate embodiment of the container of the present invention, designated generally by the reference numeral 10c. Container 10c has a vase 12c with an inner membrane 14c attached to an inner surface 24c thereof (however, it is to be understood that the inner membrane 14c may not be attached to the vase 12c). The inner membrane 14c is similar to inner membrane 14b, except that the inner membrane 14c has an inverted “bag-like” shape such that the inner membrane 14c is attached to a portion of the inner surface 24c of the vase 12c wherein the inner membrane 14c has a lower end 82c which is pointed in a direction downwardly toward a bottom 18c of the vase 12c, such that the inner membrane 14c has a cup, or funnel (concave) shape. A plant package 74c is shown in FIG. 17, wherein the plant package 74c comprises the container 10c having cut flowers 66 and water or growing or retaining medium 70 disposed therein, and having the container 10c optionally secured thereto via a securing element (not shown) as discussed previously.

Shown in FIG. 18 is another embodiment of the present invention. Container 10d is similar to container 10c in that it has an inner membrane 14d which has a shape similar to the inner membrane 14c, except the inner membrane 14d is attached to an inner surface 24d of the vase 12d in close proximity to an opening in an upper end 20d of the vase 12d.

The containers 10c and 10d are the same as containers 10-10b as described previously except for the differences as described above.

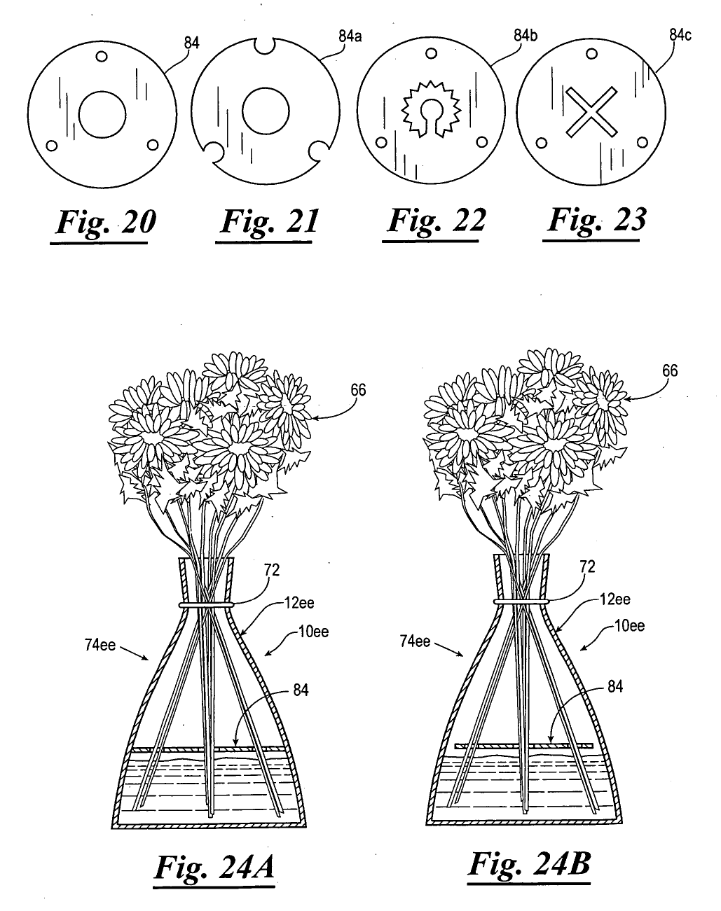

An alternate embodiment of the invention designated as container 10e is shown in FIG. 19. Container 10e as shown is substantially similar to container 10 (or any other container 10a-10d) in that it comprises a vase 12e and an inner membrane 14e attached to an inner surface 24e of the vase 12e (and cut flowers 66 and water or growing or retaining medium 70 disposed in the container 10e to form a plant package 74e). The plant package 74e differs in that container 10e further comprises a stem positioning member 84, such as but not limited to, an upper support disk constructed of a rigid or semi-rigid material, which may be a plastic or polymeric material. The stem positioning member 84 has at least one opening 86 through which at least one stem 68 of at least one cut flower 66 can be disposed. The stem 68 further passes through an opening 40e in the inner membrane 14e as previously described. The at least one opening 86 of the stem positioning member 84 can be configured in a variety of manners such as shown for example but not by way of limitation, the four openings in stem positioning members 84, 84a, 84b, and 84c in FIGS. 20-23, respectively. In one embodiment, the stem positioning member 84 (or 84a-84c) is positioned near an upper end 20e of the vase 12e. Optionally, the container 10e is secured about the cut flowers 66 by a securing element (not shown) as described herein previously. Alternatively, the stem positioning member 84 may be used alone as a support device with a vase 12ee having no inner membrane wherein the vase 12ee, stem positioning member 84, cut flowers 66 and securing element 72 disposed thereabout form a plant package 74ee (FIGS. 24A and 24B). In FIG. 24A, the stem positioning member 84 is attached to the vase 74ee; in FIG. 24B, the stem positioning member 84 is not attached to the vase 74ee.

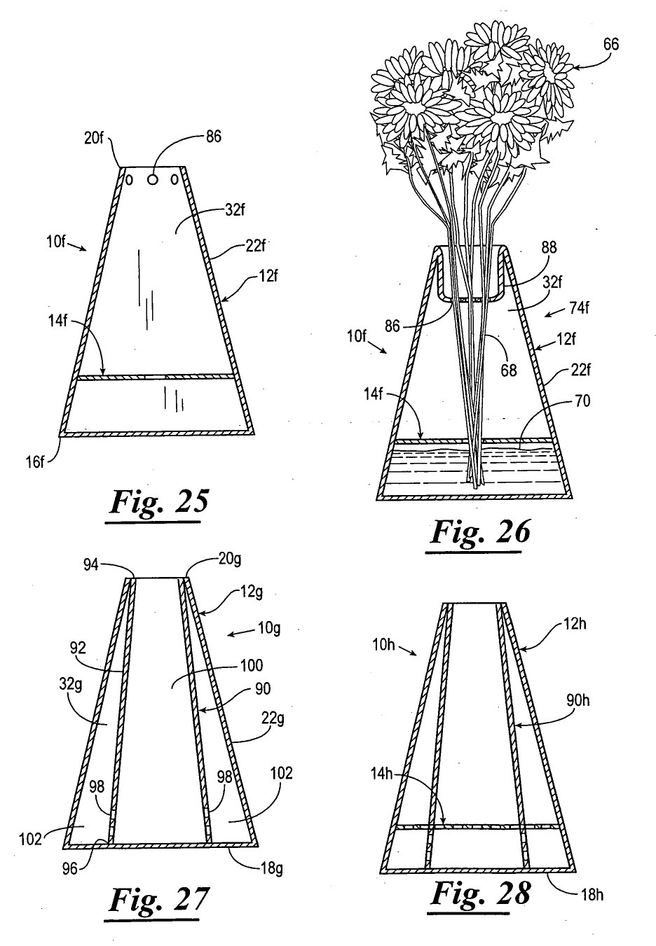

An alternate version of the invention is shown in FIGS. 25-26 as container 10f. Container 10f is similar to any of containers 10-10ee. Container 10f comprises a vase 12f and an inner membrane 14f. Vase 12f comprises a sidewall 22f, a lower end 16f, an open upper end 20f and at least one opening 86 in a portion of the sidewall 22f, such as but not limited to, in close proximity to the upper end 20f. The at least one opening 86 is sized to receive at least one stem 68 of at least one cut flower 66 therethrough. In use, an upper portion 88 of the vase 12f is inverted into an interior space 32f of the vase 12f wherein the at least one opening 86 can receive the stem 68 as shown in FIG. 26 wherein the cut flowers 66 are supported within the container 10f to form a plant package 74f.

A further embodiment of the present invention is shown in FIG. 27 and is designated as container 10g therein. Container 10g is constructed in a manner similar to any of containers 10-10f except that the inner membrane 14-14f is substituted with a membrane which has a shape of a tube, and which is designated herein as inner tube 90. The inner tube 90 is disposed within vase 12g of container 10g in a more or less vertical orientation (however, it is to be understood that the inner tube 90 may be disposed in a in a diagonal orientation, if desired). Inner tube 90 has a sidewall 92, an open upper end 94, a lower end 96, and at least one opening 98 in a lower portion of the sidewall 92 in close proximity to the lower end 96. The inner tube 90 is attached at the upper end 94 thereof to a portion of a sidewall 22g of the vase 12g near an upper end 20g thereof. Similarly, the inner tube 90 is attached at the lower end 96 thereof to a portion of a bottom 18g of the vase 12g. An interior space 32g of the vase 12g is therefore subdivided generally into a central interior space 100 within the inner tube 90 and a peripheral interior space 102 outside of the inner tube 90.

In yet another embodiment of the present invention, as shown in FIG. 28, a container 10h is provided which comprises a vase 12h, an inner membrane 14h which is similar to any of inner membranes 14-14f, and an inner tube 90h which is similar to the inner tube 90 described herein before. Inner tube 90h may be connected to inner membrane 14h and/or to a bottom 18h of the vase 12h. In other respects, container 10h is similar to any one of containers 10-10g.

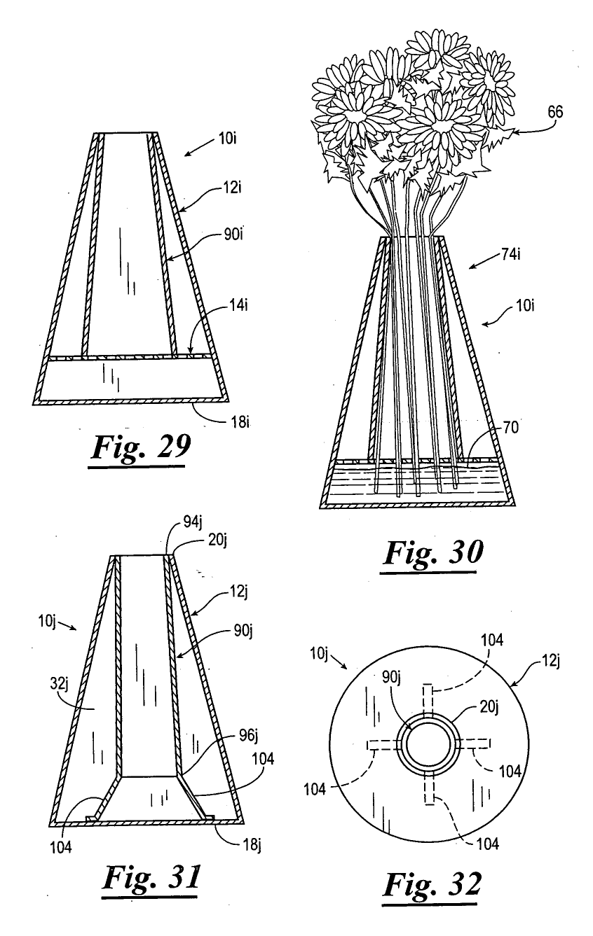

In an alternative embodiment shown in FIG. 29, the invention comprises a container 10i which comprises a vase 12i, an inner membrane 14i (similar to other inner membranes described above), and an inner tube 90i which is attached to inner membrane 14i but not to a bottom 18i of the vase 12i, in contrast to the container 10h shown in FIG. 28. FIG. 30 shows a plant package 74i comprising the container 10i, cut flowers 66 and water or growing or retaining medium 70 disposed therein. In other respects, container 10i is similar to container 10h and, where applicable, to containers 10-10g.

In yet another embodiment, the present invention comprises a container 10j as shown in FIGS. 31-33. Container 10j (as shown in FIG. 31 and in the top plan view of FIG. 32) comprises a vase 12j (having a bottom 18j and an upper end 20j), and a retaining member 90j, such as an inner tube having an upper end 94j and a lower end 96j. The inner tube retaining member 90j is connected at its upper end 94j to vase 12j in a manner similar to that shown for container 10g. However, container 10j differs from container 10g in that the lower end 96j of the inner tube retaining member 10j does not extend completely to bottom 18j of vase 12j but rather is attached thereto via at least one anchor 104. The open lower end 96j is therefore open to an interior space 32j of the vase 12j.

The term “retaining member” as used herein will be understood to refer to any structure that limits movement of an element of a floral grouping for decorative or structural purposes. While particular examples of retaining members that may be utilized in accordance with the present invention have been described herein, it is to be understood that the present invention is not limited to such embodiments; rather, any element that may function as a retaining member as described herein also falls within the scope of the present invention.

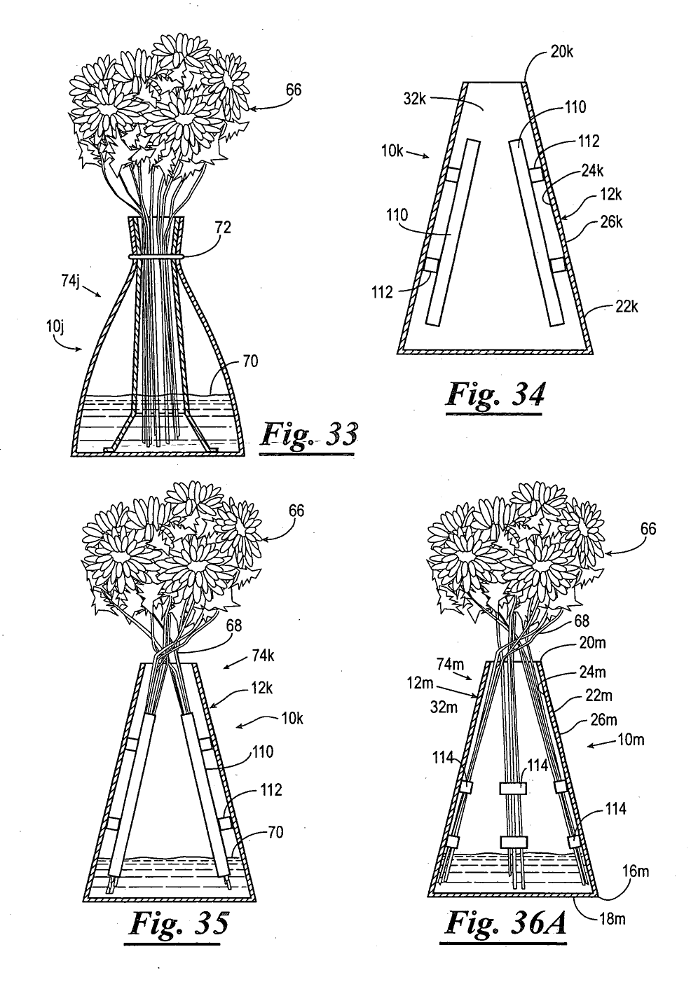

Illustrated in FIG. 33 is a plant package 74j comprising container 10j, cut flowers 66 and water or growing or retaining medium 70 disposed therein, and the container 10j secured about the cut flowers 66 via an optional securing element 72 as described previously herein. In other respects container 10j is the same as containers 10-10i, where applicable, as described elsewhere herein.

In a further embodiment, the invention comprises a container 10k as shown in FIGS. 34-35. Container 10k comprises a vase 12k having a lower end 16k comprising a sidewall 22k having an inner surface 24k and an outer surface 26k, and an interior space 32k.

The container 10k further comprises a plurality of retaining members such as tubes or tunnels 110 within the interior space 32k, each of which is attached to a portion of the inner surface 24k of the sidewall 22k either along the entire length of each tunnel 110 or along only one or more discrete portions of each tunnel 110. The tunnels 100 may be directly attached to the inner surface 24k of the sidewall 22k, or the tunnels 110 may be attached via at least one anchor 112. Each tunnel 110 is sized to contain at least one stem 68 of at least one cut flower 66 as shown in FIG. 35. A plant package 74k is shown in FIG. 35 as comprising the container 10k and at least one cut flower 66 within at least one tunnel 110 of the container 10k, and water or growing or retaining medium 70 disposed in the container 10k. Container 10k may further comprise an inner membrane as shown in any other container shown herein. Container 10k is also constructed in a manner similar to any container 10-10j as shown herein except as described above.

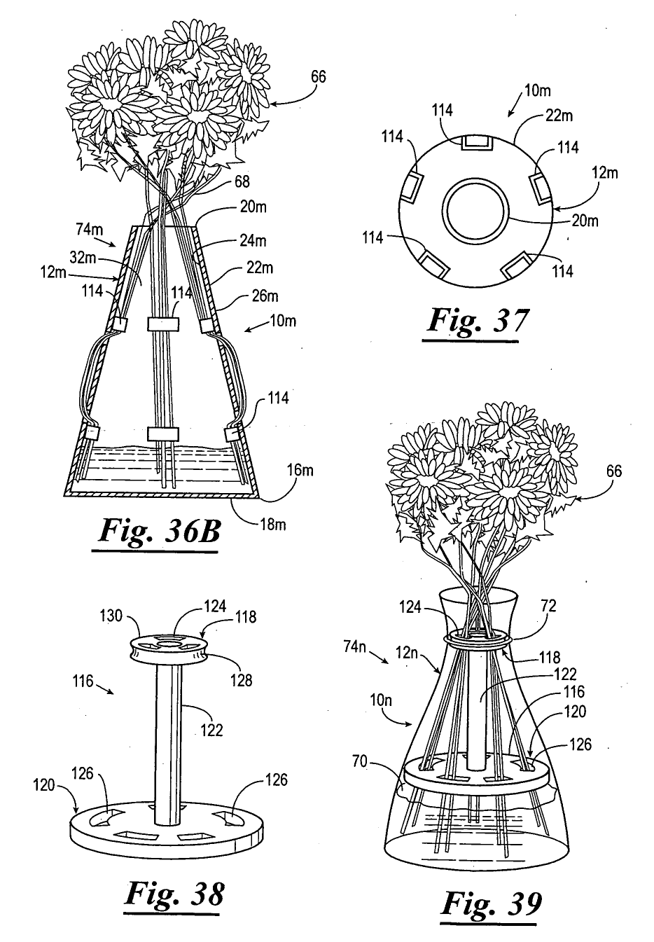

Yet another version of the invention is shown in FIGS. 36-37 as container 10m. Container 10m comprises a vase 12m which has a lower end 16m, a bottom 18m, an upper end 20m, a sidewall 22m and an outer surface 24m, and an interior space 32m. The container 10m further comprises a plurality of retaining members such as loops 114 attached to the inner surface 24m of the sidewall 22m. The loops 114 function in a manner similar to the tunnels 110 of container 10k, and in effect are miniature tunnels for holding at least one stem 68 of at least one cut flower 66 as shown in FIG. 36A (thereby providing a plant package 74m). Container 10m may further comprise an inner membrane as discussed elsewhere herein. Container 10m is also constructed in a manner similar to any of container 10-10k as shown herein except as described above.

In FIG. 36B, the plurality of loops are integrally formed in at least one layer of the material from which the vase 12m is constructed. An upper loop 114 allows a portion of a stem 68 to penetrate through at least one layer of the material from which the vase 12m is constructed, while a lower loop 114 allows the stem 68 to penetrate back through the layer(s) of material and thus be positioned within the interior space 32m. In one embodiment, the stem 68 penetrates through the outer surface 24m, while in other embodiments, a portion of the stem 68 residing between the upper and lower loops 114 is disposed within the sidewall 22m, in between the inner and outer surfaces 24m and 26m, respectively.

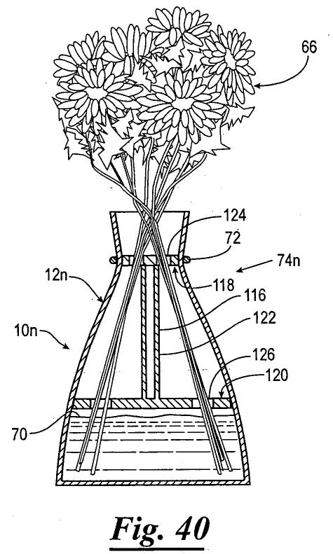

In an alternative embodiment the container of the present invention may comprise a container 10n as shown in FIGS. 38-40. FIG. 38 shows a stem support assembly 116 for supporting a plurality of cut flowers 66 disposed within the container 10n. Stem support assembly 116 comprises an upper disk 118 and a lower disk 120 which are connected via a tubular member 122. Each disk 118 and 120 has at least one, and in some embodiments, a plurality of openings 124 and 126, respectively, through which stems 68 of cut flowers 66 can be inserted. The upper disk 118 may have a diameter which is less than a diameter of the lower disk 120. Each disk 118 and 120 is shown as having a circular shape; however, it is to be understood that the disks 118 and 120 could be constructed to have a shape which corresponds to whatever shape a vase 12n of the container 10n is constructed to have in transverse cross-section, for example a square, rectangle, triangle, pentagon or hexagon. Furthermore, the upper disk 118 may have a groove 128 in the outer periphery 130 thereof for receiving a securing element 72 when such a securing element 72 is used to secure the container 10n about the stem support assembly 116 and stems 68 as shown in FIGS. 39 and 40. In use, the stem support assembly 116 is disposed within the vase 12n of the container 10n and is used to support stems 68 of cut flowers 66 inserted through the openings 124 and 126 in the disks 118 and 120. The tubular member 122 may be hollow to allow passage of water or growing or retaining medium 70 therethrough. The container 10n, including the stem support assembly 116, and cut flowers 66 comprise a plant package 74n. The stem support assembly 116 may be constructed of any material which functions in accordance with the present invention, such as but not limited to, a plastic or polymeric material.

While the invention is described herein in connection with certain embodiments so that aspects thereof may be more fully understood and appreciated, it is not intended that the invention be limited to these particular embodiments. On the contrary, it is intended that all alternatives, modifications and equivalents are included within the scope of the invention as defined by the appended claims. Thus the examples described below, which include certain embodiments, will serve to illustrate the practice of this invention, it being understood that the particulars shown are by way of example and for purposes of illustrative discussion of preferred embodiments of the present invention only and are presented in the cause of providing what is believed to be the most useful and readily understood description of procedures as well as of the principles and conceptual aspects of the invention. Changes may be made in the formulation of the various compositions described herein or in the steps or the sequence of steps of the methods described herein without departing from the spirit and scope of the invention as described and claimed herein.

What is claimed is:

1. A floral container, comprising:
a floral vase having a sidewall, an open upper end, a closed lower end, an outer surface and an inner surface encompassing an interior space; and
at least one inner membrane extending across a portion of the interior space of the vase, wherein the at least one inner membrane comprises at least one opening formed therein for allowing passage of at least one flower or plant stem therethrough.

2. The floral container of claim 1 wherein a first portion of the at least one membrane is attached to a first portion of the inner surface of the vase and at least a second portion is attached to a second portion of the inner surface of the vase.

3. The floral container of claim 1 wherein the at least one inner membrane separates the interior space of the vase into an upper interior space above the at least one inner membrane and a lower interior space below the at least one inner membrane such that the at least one opening allows passage of the at least one flower or plant stem into the lower interior space of the vase.

4. The floral container of claim 1 wherein the floral vase is rigid or semi-rigid.

5. The floral container of claim 1 wherein the floral vase is flexible.

6. The floral container of claim 1 wherein the at least one inner membrane is rigid or semi-rigid.

7. The floral container of claim 1 wherein the inner membrane is flexible.

8. The floral container of claim 1 further comprising a rigid or semi-rigid disk for supporting plant stems disposed within the interior space of the vase, the rigid or semi-rigid disk free from attachment to the inner surface of the vase.

9. The floral container of claim 1 wherein the inner membrane has a shape selected from the group consisting of substantially flat, substantially conical or convex, and substantially funnel or concave.

10. The floral container of claim 1, wherein the flexible floral vase is constructed of one or more layers of material.

11. A flexible floral container, comprising:
a flexible vase having a sidewall, an open upper end, a closed lower end, an outer surface and an inner surface encompassing an interior space; and
a plurality of retaining members attached to or formed in at least a portion of the sidewall of the vase, each retaining member sized to receive at least a portion of at least one plant stem.

12. The flexible floral container of clam 11 further comprising an inner membrane extending across a portion of the interior space.

13. The flexible floral container of claim 12, wherein a first portion of the inner membrane is attached to a first portion of the inner surface of the vase and at least a separate second portion of the inner membrane is attached to a separate second portion of the inner surface of the vase.

14. The flexible floral container of claim 11, wherein the flexible vase is formed of one or more layers of material.

15. The flexible floral container of claim 11, wherein the flexible vase is formed of at least two layers of material, and wherein the plurality of retaining members are attached to or formed in an inner layer of material.

16. A flexible floral container, comprising:
a flexible vase having a sidewall, an open upper end, a closed lower end, an outer surface and an inner surface encompassing an interior space; and
a stem support assembly comprising an upper disk, a lower disk, and a tubular member connecting the upper disk to the lower disk, the upper disk and the lower disk each having at least one opening therein, the at least one opening sized to receive a plant stem, and wherein the upper disk has a diameter which is smaller than the diameter of the lower disk.

17. The flexible floral container of clam 16 wherein the upper disk has a groove in an outer peripheral edge thereof which extends about the circumference of the upper disk, wherein the groove can receive a securing element for securing the vase to the upper disk.

18. The flexible container of clam 16 further comprising an inner membrane extending across a portion of the interior space, with a first portion of the membrane attached to a first portion of the inner surface of the vase and at least a separate second portion attached to a separate second portion of the inner surface of the vase.

19. A method of providing a plant package, comprising the steps of:
providing at least one cut flower having a stem;
providing a floral container comprising:
a floral vase having a sidewall, an open upper end, a closed lower end, an outer surface and an inner surface encompassing an interior space; and
at least one inner membrane extending across a portion of the interior space of the vase, wherein the at least one inner membrane comprises at least one opening formed therein for allowing passage of at least one flower or plant stem therethrough; and
disposing at least a portion of the stem of the at least one cut flower within the interior space of the floral vase of the floral container.

20. The method of claim 19 further comprising the step of securing the floral container about the at least one cut flower via a securing element.

21. The method of claim 19 wherein the floral vase of the floral container is rigid or semi-rigid.

22. A method of providing a plant package, comprising the steps of:
providing a plurality of cut flowers having stems;
providing a floral container comprising:
a floral vase having a sidewall, an open upper end, a closed lower end, an outer surface and an inner surface encompassing an interior space; and
at least one inner membrane extending across a portion of the interior space of the vase, wherein the at least one inner membrane comprises at least one opening formed therein for allowing passage of at least one flower or plant stem therethrough; and
disposing at least a portion of the stems of the plurality of cut flowers through the at least one opening formed in the at least one inner membrane of the floral container whereby the stems assume a tripod or tipi shape and provide structural integrity to the floral container and thus cooperate to maintain the floral container in a substantially erect condition.

23. The method of claim 22 further comprising the step of securing the floral container about the cut flowers via a securing element.

24. The method of claim 22 wherein the floral vase of the floral container is rigid or semi-rigid.

25. The method of claim 22 wherein the floral vase of the floral container is flexible.

26. The method of claim 22 wherein the at least one inner membrane of the floral container is rigid or semi-rigid.

27. The method of claim 22 wherein the at least one inner membrane of the floral container is flexible.

28. A plant package, comprising:
a floral container comprising:
a floral vase having a sidewall, an open upper end, a closed lower end, an outer surface and an inner surface encompassing an interior space; and
at least one inner membrane extending across a portion of the interior space of the vase, wherein the at least one inner membrane comprises at least one opening formed therein for allowing passage of at least one flower or plant stem therethrough; and
a plurality of cut flowers having stems, wherein at least a portion of the stems of the plurality of cut flowers are disposed through the at least one opening formed in the at least one inner membrane of the floral container whereby the stems assume a tripod or tipi shape and provide structural integrity to the floral container and thus cooperate to maintain the floral container in a substantially erect condition.

29. The plant package of claim 28, further comprising a securing element for securing the floral container about the plurality of cut flowers.
